(19) United States
(12) Patent Application Publication
(10) Pub. No.: US 2023/0132262 A1
(43) Pub. Date: Apr. 27, 2023

(54) MACHINE TOOL

(71) Applicant: FANUC CORPORATION, Minamitsuru-gun (JP)

(72) Inventor: Yuuta TOOYAMA, Minamitsuru-gun, Yamanashi-ken (JP)

(21) Appl. No.: 17/802,740

(22) PCT Filed: Feb. 26, 2021
(86) PCT No.: PCT/JP2021/007419

§ 371 Date: Aug. 26, 2022

(30) Foreign Application Priority Data
Feb. 28, 2020 (JP) 2020-032530

(51) Int. Cl. B23Q 11/00; B23Q 5/40

(52) U.S. Cl. CPC B23Q 11/0032; B23Q 5/40

(57) ABSTRACT

Provided is a machine tool which can suppress vibration of a spindle head. A machine tool according to one embodiment includes;\: a pair of guide rails which are provided on a surface of a column facing a spindle head side, and which guide the spindle head in a third direction; and a pair of drive shafts which are disposed between the pair of guide rails and are for the spindle head to move relatively in the third direction. When seen from the third direction, the center between the pair of guide rails and the center between the pair of drive shafts are positioned inside a main spindle of the spindle head.

### TECHNICAL FIELD

The present invention relates to a machine tool for machining a workpiece using a tool.

### BACKGROUND ART

JP 5638112 B1 discloses a machine tool including a saddle that moves relative to a bed, a table that moves relative to the saddle, a spindle head (spindle) that moves relative to the table, and a column that supports the spindle head. As a mechanism for relatively moving the spindle head with respect to the table, a ball screw (drive shaft) and a nut screw-engaged with the ball screw are generally used. JP 2015-074074 A discloses a machine tool having a spindle head which can be moved up and down by a ball screw/nut mechanism.

### SUMMARY OF THE INVENTION

However, in JP 2015-074074 A, since the spindle of the spindle head and the ball screw are relatively separated from each other, when the spindle head relatively moves with respect to the table, the spindle head tends to slightly move in the up-down direction with reference to the pair of drive shafts in the left-right direction. That is, since the spindle of the spindle head and the ball screw are relatively separated from each other, there is a problem that the spindle head easily vibrates when the spindle head relatively moves.

Therefore, an object of the present invention is to provide a machine tool capable of suppressing vibration of a spindle head.

According to an aspect of the present invention, there is provided a machine tool including: a saddle configured to move relative to a bed in a first direction; a table configured to move relative to the saddle in a second direction intersecting with the first direction; a spindle head configured to move relative to the table in a third direction intersecting with the first direction and the second direction; and a column configured to support the spindle head, wherein the machine tool further includes:

a pair of guide rails provided on a surface of the column that faces toward the spindle head, the guide rails being configured to guide the spindle head in the third direction; and

a pair of drive shafts disposed between the pair of guide rails and configured to cause the spindle head to relatively move in the third direction, and

wherein, when viewed from the third direction, a center between the pair of guide rails and a center between the pair of drive shafts are located inside a spindle of the spindle head.

According to this aspect of the present invention, it is possible to arrange the drive shafts and the guide rails closer to the spindle than in the case where the center between the pair of guide rails and the center between the pair of drive shafts are not located inside the spindle of the spindle head. As a result, it is possible to suppress vibration of the spindle head.

### BRIEF DESCRIPTION OF DRAWINGS

FIG. 1 is a perspective view of a machine tool according to an embodiment;

FIG. 2 is a side view of the machine tool of FIG. 1; and

FIG. 3 is a view showing a part of the machine tool viewed from above.

### DESCRIPTION OF THE INVENTION

A preferred embodiment of the present invention will be described below, in detail, with reference to the accompanying drawings.

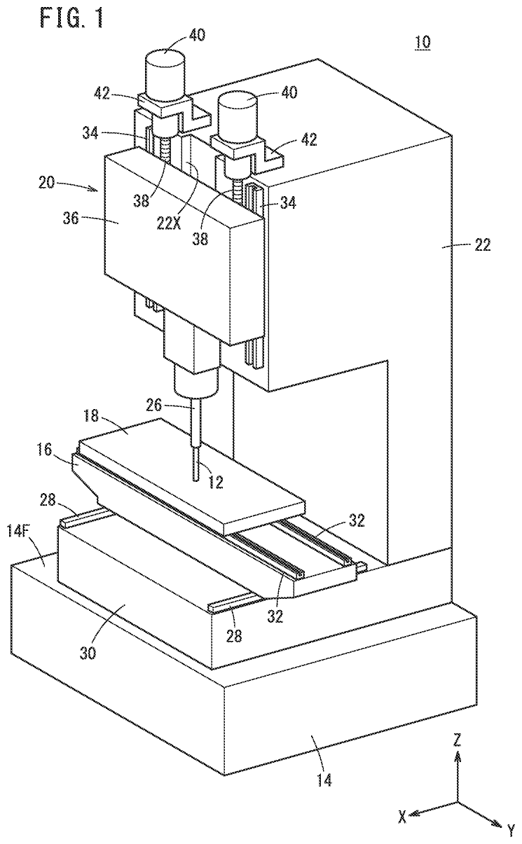

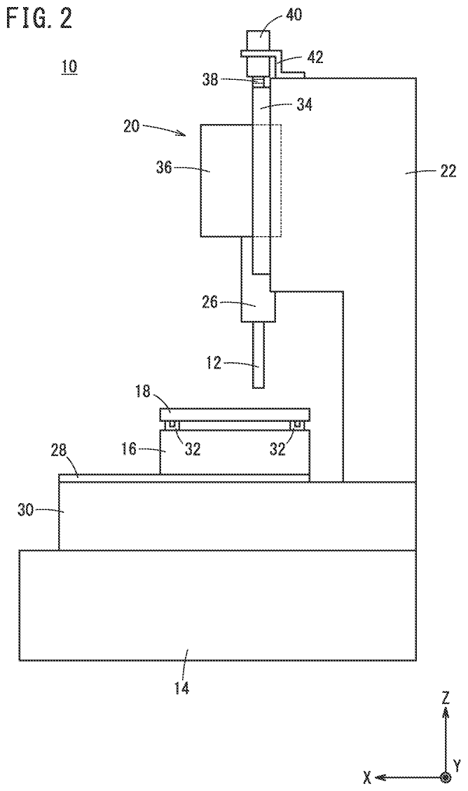

FIG. 1 is a perspective view of a machine tool 10 according to an embodiment, and FIG. 2 is a side view of the machine tool 10 of FIG. 1. The machine tool 10 machines a workpiece with a tool 12. The machine tool 10 includes a bed 14, a saddle 16, a table 18, a spindle head 20, and a column 22.

The machine tool 10 machines a workpiece fixed to the table 18, by displacing the tool 12 attached to the tip of a spindle 26 in a state where the spindle 26 of the spindle head 20 is being rotated. When displacing the tool 12, the machine tool 10 relatively moves the saddle 16 in a first direction with respect to the bed 14, relatively moves the table 18 in a second direction with respect to the saddle 16, and relatively moves the spindle head 20 in a third direction with respect to the table 18 according to a machining program.

The first direction is an X direction corresponding to the X axis of a machine coordinate system defined in the machine tool 10. A forward direction (+X direction) of the X direction is defined as a front direction (front side), and a reverse direction (−X direction) opposite to the forward direction is defined as a rear direction (rear side).

The second direction is a direction intersecting with the first direction in a plane, and is a Y direction corresponding to the Y axis of the machine coordinate system defined in the machine tool 10. A forward direction (+Y direction) of the Y direction is a right direction (right side), and a reverse direction (−Y direction) opposite to the forward direction is a left direction (left side).

The third direction is a direction intersecting with each of the first direction and the second direction, and is a Z direction corresponding to the Z axis of the machine coordinate system defined in the machine tool 10. A forward direction (+Z direction) of the Z direction is defined as an upward direction (upper side), and a reverse direction (−Z direction) opposite to the forward direction is defined as a downward direction (lower side). The downward direction is the direction in which gravity acts.

The bed 14 is a member serving as a base of the machine tool 10. The bed 14 is provided on a foundation such as the ground or a floor. A surface opposite to the foundation side of the bed 14 is an installation surface 14F for installing an object thereon.

The saddle 16 is movably coupled to a guide rail 28 that guides the saddle 16 in the front-rear direction (X direction). The guide rail 28 is installed on an upper surface of a pedestal 30 provided on the installation surface 14F of the bed 14, and extends along the front-rear direction. The number of the guide rails 28 may be one or more. When multiple guide rails 28 are provided, the multiple guide rails 28 are arranged at intervals from each other. In the present embodiment, as shown in FIG. 1, a pair of guide rails 28 are installed on the upper surface of the pedestal 30.

The saddle 16 moves along the guide rail 28 in accordance with rotation of a saddle driving motor (not shown) controlled by a numerical control device of the machine tool 10, to thereby move in the front-rear direction relative to the bed 14. When the saddle driving motor rotates in the forward direction (or in the reverse direction), the saddle 16 relatively moves in the front direction. On the other hand, when the saddle driving motor rotates in the reverse direction (or in the forward direction), the saddle 16 relatively moves in the rear direction.

The table 18 is movably coupled to a guide rail 32 that guides the table 18 in the left-right direction (Y direction). The guide rail 32 is disposed on the upper surface of the saddle 16 and extends along the left-right direction. The number of the guide rails 32 may be one or more. When multiple guide rails 32 are provided, the multiple guide rails 32 are arranged at intervals from each other. In the present embodiment, as shown in FIG. 1, a pair of guide rails 32 are installed on the upper surface of the saddle 16.

The table 18 moves along the guide rail 32 in accordance with rotation of a table driving motor (not shown) controlled by the numerical control device of the machine tool 10, to thereby move in the left-right direction relative to the saddle 16. When the table driving motor rotates in the forward direction (or in the reverse direction), the table 18 relatively moves in the right direction. On the other hand, when the table driving motor rotates in the reverse direction (or in the forward direction), the table 18 relatively moves in the left direction.

The spindle head 20 is movably coupled to a guide rail 34 that guides the spindle head 20 in the up-down direction (Z direction). The guide rail 34 is installed on a front surface (a surface on the spindle head 20 side) of the column 22, and extends along the up-down direction. The number of the guide rails 34 may be one or more. When multiple guide rails 34 are provided, the multiple guide rails 34 are arranged at intervals from each other. In the present embodiment, as shown in FIG. 1, a pair of the guide rails 34 are installed on the front surface of the column 22.

The spindle head 20 includes a spindle 26, a housing 36 through which the spindle 26 is inserted, and a bearing (not shown) that rotatably supports the spindle 26 with respect to the housing 36. The spindle 26 extends toward the table 18 below the spindle head 20, and rotates in accordance with rotation of a spindle driving motor (not shown) controlled by the numerical control device of the machine tool 10. The tool 12 attached to the tip of the spindle 26 rotates in conjunction with the rotation of the spindle 26.

The housing 36 is movably coupled to the pair of guide rails 34 and the pair of drive shafts 38, which extend in the up-down direction (Z direction). The pair of drive shafts 38 are ball screws for causing the spindle head 20 to relatively move in the up-down direction, and rotate in conjunction with a spindle head driving motor 40. The motor 40 is attached to a support member 42 that is fixed to the column 22.

The housing 36 moves along the drive shaft 38 through a nut (not shown) screw-engaged with the drive shaft 38 in accordance with the rotation of the drive shaft 38 caused by the motor 40, and also moves along the guide rail 34. Accordingly, the spindle 26 rotatably supported with respect to the housing 36 moves in the up-down direction. That is, the spindle head 20 moves along the guide rail 34 in accordance with the rotation of the motor 40, to thereby move in the up-down direction relative to the table 18. When the motor 40 rotates in the positive direction (or the negative direction), the spindle head 20 relatively moves in the upward direction. On the other hand, when the motor 40 rotates in the reverse direction (or in the forward direction), the spindle head 20 relatively moves in the downward direction.

The column 22 supports the spindle head 20. The column 22 is installed on the pedestal 30.

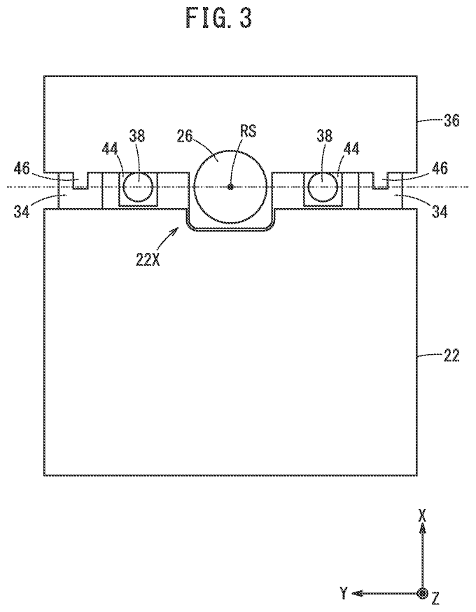

FIG. 3 is a view showing a part of the machine tool 10 viewed from above. In FIG. 3, the motor 40 and the support member 42 are omitted.

A pair of nuts 44 are attached to a rear surface (a surface facing toward the column 22) of the housing 36. The nuts 44 are screw-engaged with the pair of drive shafts (ball screws) 38, respectively. A pair of fitting portions 46 which are slidably fitted into the pair of guide rails 34 are provided on a rear surface (surface facing toward the column 22) of the housing 36. The pair of nuts 44 are located inside the pair of fitting portions 46.

The center between the pair of drive shafts 38 onto which the pair of nuts 44 are screw-engaged and the center between the pair of guide rails 34 into which the pair of fitting portions 46 are fitted are located inside the spindle 26 when viewed from the third direction (FIG. 3). With the above configuration, the drive shafts 38 and the guide rails 34 can be disposed closer to the spindle 26 than in the case where the center between the pair of drive shafts 38 and the center between the pair of guide rails 34 are not located inside the spindle 26. As a result, vibration of the spindle head 20 can be suppressed.

The center between the pair of drive shafts 38 and the center between the pair of guide rails 34 may coincide with the rotation center RS of the spindle 26 when viewed from the third direction (FIG. 3). In the case where the center between the pair of drive shafts 38 and the center between the pair of guide rails 34 coincide with the rotation center RS of the spindle 26, the amount of protrusion of the spindle head 20 protruding from the column 22 in the first direction can be suppressed as much as possible, and the spindle head 20 can be stabilized, compared to the case where they do not coincide.

Further, the center between the pair of drive shafts 38 and the center between the pair of guide rails 34 may coincide with the center of gravity of the spindle head 20 when viewed from the third direction (FIG. 3). When the center between the pair of drive shafts 38 and the center between the pair of guide rails 34 coincide with the center of gravity of the spindle head 20, the spindle head 20 can be stabilized further than when they do not coincide with each other. When viewed from the third direction (FIG. 3), the center between the pair of drive shafts 38, the center between the pair of guide rails 34, and the center of gravity of the spindle head 20 may be located inside the spindle 26.

Further, as shown in FIG. 3, a recess 22X may be formed in the front surface of the column 22 between the pair of drive shafts 38, and part of the spindle 26 may be accommodated inside the recess 22X. When part of the spindle 26 is accommodated inside the recess 22X, it becomes easy for the center between the pair of drive shafts 38 and the center between the pair of guide rails 34 to coincide with the rotation center RS of the spindle 26.

### INVENTION

The invention that can be understood from the above embodiment will be described below.

The machine tool (10) includes: a saddle (16) configured to move relative to a bed (14) in a first direction; a table (18) configured to move relative to the saddle (16) in a second direction intersecting with the first direction; a spindle head (20) configured to move relative to the table (18) in a third direction intersecting with the first direction and the second direction; and a column (22) configured to support the spindle head (20). The machine tool (10) further includes a pair of guide rails (34) provided on a surface of the column (22) that faces toward the spindle head (20), the guide rails being configured to guide the spindle head (20) in the third direction; and a pair of drive shafts (38) disposed between the pair of guide rails (34) and configured to cause the spindle head (20) to relatively move in the third direction. When viewed from the third direction, the center between the pair of guide rails (34) and the center between the pair of drive shafts (38) are located inside the spindle (26) of the spindle head (20).

With the above configuration, the drive shafts (38) and the guide rails (34) can be disposed closer to the spindle (26) than in the case where the center between the pair of drive shafts (38) and the center between the pair of guide rails (34) are not located inside the spindle (26). As a result, vibration of the spindle head (20) can be suppressed.

When viewed from the third direction, the center between the pair of guide rails (34) and the center between the pair of drive shafts (38) may coincide with the rotation center (RS) of the spindle (26). With this configuration, as compared with the case where the center between the pair of guide rails (34) and the center between the pair of drive shafts (38) do not coincide with the rotation center (RS) of the spindle (26), the amount of protrusion of the spindle head (20) protruding from the column (22) in the first direction can be minimized, and the spindle head (20) can be stabilized.

A recess (22X) may be formed in the surface of the column (22) between the pair of drive shafts (38), and part of the spindle (26) may be accommodated inside the recess (22X). This makes it easy for the center between the pair of drive shafts (38) and the center between the pair of guide rails (34) to coincide with the rotation center (RS) of the spindle (26).

1. A machine tool comprising: a saddle configured to move relative to a bed in a first direction; a table configured to move relative to the saddle in a second direction intersecting with the first direction; a spindle head configured to move relative to the table in a third direction intersecting with the first direction and the second direction; and a column configured to support the spindle head, wherein the machine tool further comprises:
a pair of guide rails provided on a surface of the column that faces toward the spindle head, the guide rails being configured to guide the spindle head in the third direction; and
a pair of drive shafts disposed between the pair of guide rails and configured to cause the spindle head to relatively move in the third direction, and
wherein, when viewed from the third direction, a center between the pair of guide rails and a center between the pair of drive shafts are located inside a spindle of the spindle head.

2. The machine tool according to claim 1, wherein
when viewed from the third direction, the center between the pair of guide rails and the center between the pair of drive shafts coincide with a rotation center of the spindle.

3. The machine tool according to claim 1, wherein
a recess is formed in the surface of the column between the pair of drive shafts, and part of the spindle is accommodated inside the recess.
